(19) United States
(12) Patent Application Publication
(10) Pub. No.: US 2003/0148912 A1
(43) Pub. Date: Aug. 7, 2003

(54) Detergent and cleaning agent shaped bodies wih improved disintegration properties

(76) Inventor: Manfred Weuthen, Langenfeld (DE)

Correspondence Address: COGNIS CORPORATION, 2500 RENAISSANCE BLVD., SUITE 200, GULPH MILLS, PA, 19406

(21) Appl. No.: 10/168,743

(22) PCT Filed: Dec. 15, 2000
(86) PCT No.: PCT/EP00/12815

(30) Foreign Application Priority Data
Dec. 24, 1999 (DE) 19962885.8

(51) Int. Cl. C11D 17/00

(52) U.S. Cl. 510/421; 510/447

(57) ABSTRACT

A cleaning composition having a compacted particulate premix, the premix containing: (a) a hydroxy mixed ether; (b) a surfactant other than the hydroxy mixed ether; and (c) a builder, and wherein the composition is in solid form.

### FIELD OF THE INVENTION

The present invention is situated in the field of compact shaped bodies which have wash-active and detersive properties. The invention relates in particular to shaped laundry detergent and cleaning product bodies used for washing textiles in a domestic washing machine and referred to for short as laundry detergent tablets.

### PRIOR ART

Laundry detergent and cleaning product tablets are widely described in the prior art and are enjoying increasing popularity among users on account of the ease of metering. Tableted laundry detergents and cleaning products have a number of advantages over their powder-form counterparts: they are easier to meter and handle and their compact structure gives advantages in storage and transport. In the patent literature as well, therefore, laundry detergent and cleaning product tablets have been comprehensively described. One problem which occurs again and again in connection with the use of wash-active and detersive tablets is the insufficient disintegration and dissolution rate of the tablets under service conditions. Since sufficiently stable tablets, i.e., dimensionally stable and fracture-resistant tablets, can be produced only by means of relatively high compressive pressures, there is severe compaction of the tablet constituents and, consequently, retarded disintegration of the tablet in the aqueous liquor, and thus excessively slow release of the active substances in the washing or cleaning operation. The retarded disintegration of the tablets has the further disadvantage that customary laundry detergent and cleaning product tablets cannot be rinsed in via the dispenser drawer of domestic washing machines, since the tablets do not break down with sufficient rapidity into secondary particles which are small enough to be rinsed out of the dispenser drawer into the washing drum.

To overcome the dichotomy between hardness, i.e., transport and handling stability, and ready disintegration of the tablets, many proposed solutions have been developed in the prior art. One approach, which is known in particular from pharmacy and has expanded into the field of laundry detergent and cleaning product tablets, is the incorporation of certain disintegration aids, which facilitate the ingress of water or which swell on ingress of water, and exert a disintegrating action by evolving gas or in some other form. Other proposed solutions from the patent literature describe the compression of premixes of specific particle sizes, the separation of individual ingredients from certain other ingredients, and the coating of individual ingredients or of the entire tablet with binders.

For instance, EP-A1 0522766 (Unilever) discloses tablets of a compacted, particulate laundry detergent composition comprising surfactants, builders and disintegration aids (based on cellulose, for example), at least some of the particles being coated with the disintegrant, which has both a binder effect and a disintegrating effect when the tablets are dissolved in water. This document also points to the general difficulty of producing tablets combining adequate stability with good solubility. The particle size in the mixture to be compressed is said in this case to be above 200 μm, the intention being that the upper and lower limits of the individual particle sizes differ from one another by not more than 700 μm. Further documents which concern themselves with the production of laundry detergent tablets are EP 0716144 A1 (Unilever), which describes tablets having an external shell of water-soluble material, and EP 0711827 A1 (Unilever), where one ingredient is a citrate having a defined solubility. The use of binders which may develop a disintegrating action (especially polyethylene glycol) is described in EP 0711828 A1 (Unilever), which describes laundry detergent tablets produced by compressing a particulate laundry detergent composition at temperatures between 28° C. and the melting point of the binder material, compression always taking place at below the melting temperature. The examples of that document reveal that the tablets produced in accordance with its teaching have higher fracture strengths if compression is carried out at elevated temperature. Laundry detergent tablets in which individual ingredients are present separately from others are also described in EP 0481793 A1 (Unilever). The laundry detergent tablets disclosed in that document comprise sodium percarbonate, which is spatially separate from all other components that might affect its stability. Subject matter of DE 19854289 A1 (Henkel), finally, are laundry detergent tablets comprising nonionic surfactants of the alkyl polyglycoside type.

It is an object of the present invention, accordingly, to provide laundry detergent and cleaning product tablets which unite the desired properties of high hardness and mechanical stability with favorable disintegration rates.

### DESCRIPTION OF THE INVENTION

The present invention provides laundry detergent and cleaning product tablets comprising compacted particulate precursors, comprising surfactants, builders and also, where appropriate, further laundry detergent and cleaning product ingredients, which are distinguished in that they comprise surfactants from the group of the hydroxy mixed ethers.

Surprisingly it has been found that laundry detergent tablets of high hardness and yet with an extremely high disintegration rate can be produced by using nonionic surfactants of the hydroxy mixed ether (HME) type when producing the laundry detergent and cleaning agent formulation. The invention includes the finding that the performance properties of the tablets can be improved further if the HMEs are used together with other surfactants, preferably alkyl oligoglycosides.

Hydroxy Mixed Ethers

Hydroxy mixed ethers (HMEs) represent known nonionic surfactants having an asymmetric ether structure and containing polyalkylene glycol fractions, and are obtained, for example, by subjecting olefin epoxides to a ring-opening reaction with fatty alcohol polyglycol ethers. Products of this kind and their use in the field of the cleaning of hard surfaces are the subject matter, for example, of European patent EP 0693049 B1 and of international patent application WO 94/22800 (Olin) and the texts specified therein. The hydroxy mixed ethers typically conform to the general formula (I).

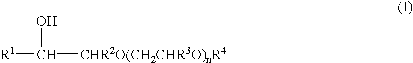

in which R¹ is a linear or branched alkyl radical having from 2 to 18, preferably from 10 to 16, carbon atoms, R² is hydrogen or a linear or branched alkyl radical having from 2 to 18 carbon atoms, R³ is hydrogen or methyl, R⁴ is a linear or branched alkyl and/or alkenyl radical having from 6 to 22, preferably from 12 to 18, carbon atoms, and n stands for numbers from 1 to 50, preferably from 2 to 25, and in particular from 5 to 15, with the proviso that the sum of the carbon atoms in the radicals R¹ and R² is at least 4 and preferably from 12 to 18. As is evident from the formula, the HMEs may be ring-opening products either in internal olefins (R² is other than hydrogen) or terminal olefins (R² is hydrogen), the latter being preferred in respect of easier preparation and the more advantageous performance properties. Similarly, the polar moiety of the molecule may be a polyethylene glycol chain or a polypropylene glycol chain; likewise suitable are mixed chains of PE and PP units, whether in random or block distribution. Typical examples are ring-opening products of 1,2-hexene epoxide, 2,3-hexene epoxide, 1,2-octene epoxide, 2,3-ocetene epoxide, 3,4-octene epoxide, 1,2-decene epoxide, 2,3-decene epoxide, 3,4-decene epoxide, 4,5-decene epoxide, 1,2-dodecene epoxide, 2,3-dodecene epoxide, 3,4-dodecene epoxide, 4,5-dodecene epoxide, 5,6-dodecene epoxide, 1,2-tetradecene epoxide, 2,3-tetradecene epoxide, 3,4-tetradecene epoxide, 4,5-tetradecene epoxide, 5,6-tetradecene epoxide, 6,7-tetradecene epoxide, 1,2-hexadecene epoxide, 2,3-hexadecene epoxide, 3,4-hexadecene epoxide, 4,5-hexadecene epoxide, 5,6-hexadecene epoxide, 6,7-hexadecene epoxide, 7,8-hexadecene epoxide, 1,2-octadecene epoxide, 2,3-octadecene epoxide, 3,4-octadecene epoxide, 4,5-octadecene epoxide, 5,6-octadecene epoxide, 6,7-octadecene epoxide, 7,8-octadecene epoxide, and 8,9-octadecene epoxide, and their mixtures with adducts of on average from 1 to 50, preferably from 2 to 25, and in particular from 5 to 15 mol of ethylene oxide and/or from 1 to 10, preferably from 2 to 8, and in particular from 3 to 5 mol of propylene oxide with saturated and/or unsaturated primary alcohols having from 6 to 22, preferably from 12 to 18, carbon atoms, such as caproyl alcohol, caprylyl alcohol, 2-ethylhexyl alcohol, capryl alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcohol, erucyl alcohol, and brassidyl alcohol, and their technical-grade mixtures. In the tablets the HMEs are normally present in amounts of from 0.1 to 20%, preferably from 0.5 to 8%, and in particular from 3 to 5% by weight.

Surfactants

In a first special embodiment of the present invention the tablets may comprise the HMEs together with further anionic, nonionic, cationic, amphoteric and/or zwitterionic surfactants; preferably, however, anionic surfactants or combinations of anionic and nonionic surfactants are present. Typical examples of anionic surfactants are soaps, alkylbenzenesulfonates, alkanesulfonates, olefinsulfonates, alkyl ether sulfonates, glycerol ether sulfonates, α-methyl ester sulfonates, sulfo fatty acids, alkyl sulfates, fatty alcohol ether sulfates, glycerol ether sulfates, hydroxy mixed ether sulfates, monoglyceride (ether) sulfates, fatty acid amide (ether) sulfates, mono- and dialkylsulfosuccinates, mono- and dialkylsulfosuccinamates, sulfotriglycerides, amide soaps, ethercarboxylic acids and their salts, fatty acid isethionates, fatty acid sarcosinates, fatty acid taurides, N-acylamino acids such as, for example, acyllactylates, acyltartrates, acylglutamates, and acylaspartates, alkyl oligoglucoside sulfates, protein fatty acid condensates (especially plant products based on wheat), and alkyl (ether) phosphates. Where the anionic surfactants contain polyglycol ether chains these chains may have a conventional or, preferably, a narrowed homolog distribution. Preference is given to using alkylbenzenesulfonates, alkyl sulfates, soaps, alkanesulfonates, olefinsulfonates, methyl ester sulfonates, and mixtures thereof. Preferred alkylbenzenesulfonates conform preferably to the formula (II)

R⁵—Ph—SO₃X (II)

in which R⁵ is a branched or, preferably, linear alkyl radical having from 10 to 18 carbon atoms, Ph is a phenyl radical, and X is an alkali metal and/or alkaline earth metal, ammonium, alkylammonium, alkanolammonium or glucammonium. Of these, particular suitability is possessed by dodecylbenzenesulfonates, tetradecylbenzenesulfonates, hexadecylbenzenesulfonates, and their technical-grade mixtures in the form of the sodium salts.

Alkyl and/or alkenyl sulfates, frequently also referred to as fatty alcohol sulfates, are the sulfation products of primary and/or secondary alcohols, conforming preferably to the formula (III)

R⁶O—SO₃X (III)

in which R⁶ is a linear or branched, aliphatic alkyl and/or alkenyl radical having from 6 to 22, preferably from 12 to 18, carbon atoms, and X is an alkali metal and/or alkaline earth metal, ammonium, alkylammonium, alkanolammonium or glucammonium. Typical examples of alkyl sulfates that may be used in the context of the invention are the sulfation products of caproyl alcohol, caprylyl alcohol, capryl alcohol, 2-ethylhexyl alcohol, lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, and erucyl alcohol, and also their technical-grade mixtures obtained by high-pressure hydrogenation of industrial methyl ester fractions or aldehydes from the Roelen oxo process. The sulfation products may be used preferably in the form of their alkali metal salts and in particular of their sodium salts. Particular preference is given to alkyl sulfates based on C_{16/18} tallow fatty alcohols or vegetable fatty alcohols of comparable carbon chain distribution in the form of their sodium salts. In the case of branched primary alcohols they are oxo alcohols, such as are obtainable, for example, by reacting carbon monoxide and hydrogen onto alpha-positioned olefins by the Shop process. Alcohol mixtures of this kind are available commercially under the trade names Dobanol® or Neodol®. Suitable alcohol mixtures are Dobanol 91®, 23®, 25®, 45®. A further possibility are oxo alcohols such as are obtained by the classic oxo process of Enichema or Condea, by addition reaction of carbon monoxide and hydrogen with olefins. These alcohol mixtures comprise a mixture of highly branched alcohols. Alcohol mixtures of this kind are available commercially under the trade name Lial®. Suitable alcohol mixtures are Lial 91®, 111®, 123®, 125®, 145®.

By soaps, finally, are meant fatty acid salts of the formula (IV)

R⁷CO—OX (IV)

in which R⁷CO is a linear or branched, saturated or unsaturated acyl radical having from 6 to 22 and preferably from 12 to 18 carbon atoms, and again X is alkali metal and/or alkaline earth metal, ammonium, alkylammonium or alkanolammonium. Typical examples are the sodium, potassium, magnesium, ammonium, and triethanolammonium salts of caproic acid, caprylic acid, 2-ethylhexanoic acid, capric acid, lauric acid, isotridecanoic acid, myristic acid, palmitic acid, palmoleic acid, stearic acid, isostearic acid, oleic acid, elaidic acid, petroselinic acid, linoleic acid, linolenic acid, elaeostearic acid, arachic acid, gadoleic acid, behenic acid, and erucic acid, and also their technical-grade mixtures. Preference is given to using coconut or palm kernel fatty acid in the form of their sodium or potassium salts.

Typical examples of nonionic surfactants are fatty alcohol polyglycol ethers, alkylphenol polyglycol ethers, fatty acid polyglycol esters, fatty acid amide polyglycol ethers, fatty amine polyglycol ethers, alkoxylated triglycerides, mixed ethers and mixed formals, alk(en)yl oligoglycosides, fatty acid N-alkylglucamides, protein hydrolysates (especially plant products based on wheat), polyol fatty acid esters, sugar esters, sorbitan esters, polysorbates, and amine oxides. Where the nonionic surfactants contain polyglycol ether chains, these chains may have a conventional or, preferably, a narrowed homolog distribution. Preference is given to using fatty alcohol polyglycol ethers, alkoxylated fatty acid lower alkyl esters or alkyl oligoglucosides.

The preferred fatty alcohol polyglycol ethers conform to the formula (V)

R⁸O(CH₂CHR⁹O)ₙ₁H (V)

in which R⁸ is a linear or branched alkyl and/or alkenyl radical having from 6 to 22, preferably from 12 to 18, carbon atoms, R⁹ is hydrogen or methyl, and n1 stands for numbers from 1 to 20. Typical examples are the adducts with an average from 1 to 20 and preferably from 5 to 10 mol of ethylene oxide and/or propylene oxide onto caproyl alcohol, caprylyl alcohol, 2-ethylhexyl alcohol, capryl alcohol, lauryl alcohol, isotridecyl alcohol, myristyl alcohol, cetyl alcohol, palmoleyl alcohol, stearyl alcohol, isostearyl alcohol, oleyl alcohol, elaidyl alcohol, petroselinyl alcohol, linolyl alcohol, linolenyl alcohol, elaeostearyl alcohol, arachyl alcohol, gadoleyl alcohol, behenyl alcohol, erucyl alcohol, and brassidyl alcohol, and their technical-grade mixtures. Particular preference is given to adducts of 3, 5 or 7 mol of ethylene oxide with technical-grade coconut fatty alcohols.

Suitable alkoxylated fatty acid lower alkyl esters are surfactants of the formula (VI)

R¹⁰CO—(OCH₂CHR¹¹)ₙ₂OR¹² (VI)

in which R¹⁰CO is a linear or branched, saturated and/or unsaturated acyl radical having from 6 to 22 carbon atoms, R¹¹ is hydrogen or methyl, R¹² is linear or branched alkyl radicals having from 1 to 4 carbon atoms, and n2 stands for numbers from 1 to 20. Typical examples are the formal insertion products of on average from 1 to 20 and preferably from 5 to 10 mol of ethylene oxide and/or propylene oxide into the methyl, ethyl, propyl, isopropyl, butyl, and tert-butyl esters of caproic acid, caprylic acid, 2-ethylhexanoic acid, capric acid, lauric acid, isotridecanoic acid, myristic acid, palmitic acid, palmoleic acid, stearic acid, isostearic acid, oleic acid, elaidic acid, petroselinic acid, linoleic acid, linolenic acid, eleostearic acid, arachic acid, gadoleic acid, behenic acid, and erucic acid, and also their technical-grade mixtures. The products are normally prepared by inserting the alkylene oxides into the carbonyl ester linkage in the presence of special catalysts, such as calcined hydrotalcite, for example. Particular preference is given to reaction products of on average from 5 to 10 mol of ethylene oxide into the ester linkage of technical-grade coconut fatty acid methyl esters. Alkyl and alkenyl oligoglycosides, likewise preferred nonionic surfactants, customarily conform to the formula (VII)

R¹³O-[G]ₚ (VII)

in which R¹³ is an alkyl and/or alkenyl radical having from 4 to 22 carbon atoms, G is a sugar radical having 5 or 6 carbon atoms, and p stands for numbers from 1 to 10. They may be obtained by the relevant processes of preparative organic chemistry. As representatives of the extensive literature, reference may be made here to the documents EP-A1 0301298 and WO 90/03977. The alkyl and/or alkenyl oligoglycosides may derive from aldoses and/or ketoses having 5 or 6 carbon atoms, preferably from glucose. The preferred alkyl and/or alkenyl oligoglycosides are therefore alkyl and/or alkenyl oligoglucosides. The index p in the general formula (VII) indicates the degree of oligomerization (DP), i.e., the distribution of monoglycosides and oligoglycosides, and stands for a number between 1 and 10. While p in a given compound must always be integral and in this case may adopt in particular the values p=1 to 6, p for a particular alkyl oligoglycoside is an analytically determined arithmetic variable which usually represents a fraction. Preference is given to using alkyl and/or alkenyl oligoglycosides having an average degree of oligomerization p of from 1.1 to 3.0. From a performance standpoint, preference is given to alkyl and/or alkenyl oligoglycosides whose degree of oligomerization is less than 1.7 and is in particular between 1.2 and 1.4. The alkyl and/or alkenyl radical R¹³ may derive from primary alcohols having from 4 to 11, preferably from 8 to 10, carbon atoms. Typical examples are butanol, caproyl alcohol, caprylyl alcohol, capryl alcohol, and undecyl alcohol, and their technical-grade mixtures, as obtained, for example, in the hydrogenation of technical-grade fatty acid methyl esters or in the course of the hydrogenation of aldehydes from the Roelen oxo process. Preference is given to alkyl oligoglucosides of chain length C₈-C₁₀ (DP=1 to 3), which are obtained as the initial fraction during the distillative separation of technical-grade C₈-C₁₈ coconut fatty alcohol and may have an impurities fraction of less than 6% by weight of C₁₂ alcohol, and also alkyl oligoglucosides based on technical-grade C_{9/11} oxo alcohols (DP=1 to 3). The alkyl and/or alkenyl radical R¹³ may also derive from primary alcohols having from 12 to 22, preferably from 12 to 14, carbon atoms. Typical examples are lauryl alcohol, myristyl alcohol, cetyl alcohol, palmoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol, and their technical-grade mixtures, which may be obtained as described above. Preference is given to alkyl oligoglucosides based on hydrogenated C_{12/14} cocoyl alcohol with a DP of from 1 to 3.

Typical examples of cationic surfactants are in particular, tetraalkylammonium compounds, such as, for example, dimethyldistearylammonium chloride or hydroxyethyl hydroxycetyl dimmonium chloride (Dehyquart E) or else ester quats. These comprise, for example, quaternized fatty acid triethanolamine ester salts of the formula (VIII)

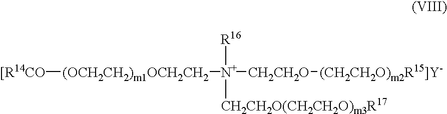

in which R¹⁴CO is an acyl radical having from 6 to 22 carbon atoms, R¹⁵ and R¹⁶ independently of one another are hydrogen or R¹⁴Co, R¹⁵ is an alkyl radical having from 1 to 4 carbon atoms or a (CH₂CH₂O)ₓ₄H group, m1, m2 and m3 in total stand for 0 or numbers from 1 to 12, m4 stands for numbers from 1 to 12, and Y is halide, alkyl sulfate or alkyl phosphate. Typical examples of ester quats which may be used in the context of the invention are products based on caproic acid, caprylic acid, capric acid, lauric acid, myristic acid, palmitic acid, isostearic acid, stearic acid, oleic acid, elaidic acid, arachic acid, behenic acid, and erucic acid, and also their technical-grade mixtures as produced, for example, in the pressure cracking of natural fats and oils. Preference is given to using technical-grade C_{12/18} coconut fatty acids and especially partially hydrogenated C_{16/18} tallow and/or palm fatty acids and also C_{16/18} fatty acid cuts rich in elaidic acid. For preparing the quaternized esters, the fatty acids and the triethanolamine may be used in a molar ratio of from 1.1:1 to 3:1. In view of the performance properties of the ester quats, a ratio of from 1.2:1 to 2.2:1, preferably from 1.5:1 to 1.9:1, has proven particularly advantageous. The preferred ester quats constitute technical-grade mixtures of monoesters, diesters and triesters with an average degree of esterification of from 1.5 to 1.9 and derive from technical-grade C_{16/18} tallow and/or palm fatty acid (iodine number from 0 to 40). From a performance stand-point, quaternized fatty acid triethanolamine ester salts of the formula (VIII) have proven particularly advantageous in which R¹⁴CO is an acyl radical having from 16 to 18 carbon atoms, R¹ is R¹⁵CO, R¹⁶ is hydrogen, R¹⁷ is a methyl group, m1, m2 and m3 stand for 0, and Y is methyl sulfate.

Besides the quaternized fatty acid triethanolamine ester salts, further suitable ester quats include quaternized ester salts of fatty acids with diethanol-alkylamines of the formula (IX)

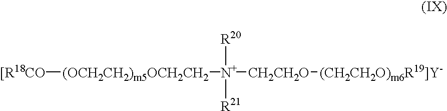

in which R¹⁸CO is an acyl radical having from 6 to 22 carbon atoms, R¹⁹ is hydrogen or R¹⁸CO, R²⁰ and R²¹ independently of one another are alkyl radicals having from 1 to 4 carbon atoms, m5 and m6 in total stand for 0 or numbers from 1 to 12, and Y again is halide, alkyl sulfate or alkyl phosphate.

As a further group of suitable ester quats, finally, mention may be made of the quaternized ester salts of fatty acids with 1,2-dihydroxypropyldialkylamines of the formula (X)

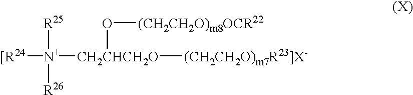

in which R²²CO is an acyl radical having from 6 to 22 carbon atoms, R²³ is hydrogen or R²²CO, R²⁴, R²⁵, and R²⁶ independently of one another are alkyl radicals having from 1 to 4 carbon atoms, m7 and m8 in total stand for 0 or numbers from 1 to 12, and X again is halide, alkyl sulfate or alkyl phosphate.

Finally, suitable ester quats further include substances in which the ester linkage has been replaced by an amide linkage and which preferably, based on diethylenetriamine, conform to the formula (XI)

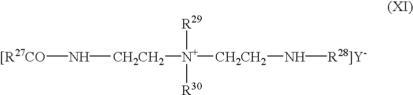

in which R²⁷CO is an acyl radical having from 6 to 22 carbon atoms, R²⁸ is hydrogen or R²⁷CO, R²⁹ and R³⁰ independently of one another are alkyl radicals having from 1 to 4 carbon atoms, and Y is halide, alkyl sulfate or alkyl phosphate. Amide ester quats of this kind are available on the market under the name Incroquat® (Croda), for example.

Examples of suitable amphoteric or zwitterionic surfactants are alkyl betaines, alkylamido betaines, aminopropionates, aminoglycinates, imidazolinium betaines, and sulfo betaines. Examples of suitable alkyl betaines are the carboxyalkylation products of secondary and especially tertiary amines which conform to the formula (XII)

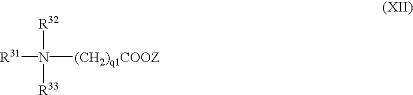

in which R³¹ stands for alkyl and/or alkenyl radicals having from 6 to 22 carbon atoms, R³² stands for hydrogen or alkyl radicals having from 1 to 4 carbon atoms, R³³ stands for alkyl radicals having from 1 to 4 carbon atoms, q1 stands for numbers from 1 to 6, and Z is an alkali metal and/or alkaline earth metal or ammonium. Typical examples are the carboxymethylation products of hexylmethylamine, hexyldimethylamine, octyldimethylamine, decyldimethylamine, dodecylmethylamine, dodecyldimethylamine, dodecylethylmethylamine, C_{12/14} cocoalkyldimethylamine, myristyldimethylamine, cetyldimethylamine, stearyldimethylamine, stearylethylmethylamine, oleyldimethylamine, C_{16/18} tallow alkyldimethylamine, and also their technical-grade mixtures. Also suitable, moreover, are carboxyalkylation products of amidoamines, which conform to the formula (XIII)

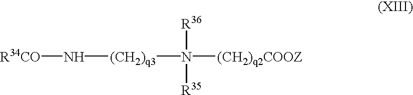

in which R³⁴CO is an aliphatic acyl radical having from 6 to 22 carbon atoms and 0 or from 1 to 3 double bonds, R³⁵ stands for hydrogen or alkyl radicals having 1 to 4 carbon atoms, R³⁶ stands for alkyl radicals having from 1 to 4 carbon atoms, q2 stands for numbers from 1 to 6, q3 stands for numbers from 1 to 3, and Z again is an alkali metal and/or alkaline earth metal or ammonium. Typical examples are reaction products of fatty acids having from 6 to 22 carbon atoms, namely caproic acid, caprylic acid, capric acid, lauric acid, myristic acid, palmitic acid, palmoleic acid, stearic acid, isostearic acid, oleic acid, elaidic acid, petroselinic acid, linoleic acid, linolenic acid, eleostearic acid, arachic acid, gadoleic acid, behenic acid, and erucic acid, and also their technical-grade mixtures, with N,N-dimethylaminoethylamine, N,N-dimethylaminopropylamine, N,N-diethylaminoethylamine, and N,N-diethylaminopropylamine, these products being condensed with sodium chloroacetate. Preference is given to the use of a condensation product of C_{8/18} coconut fatty acid N,N-dimethylaminopropyl amide with sodium chloroacetate.

Also suitable, furthermore, are imidazolinium betaines. These substances are also known substances, which may be obtained, for example, by cyclizing condensation of 1 or 2 mol of fatty acid with polyfunctional amines such as aminoethylethanolamine (AEEA) or diethylenetriamine, for example. The corresponding carboxyalkylation products are mixtures of different open-chain betaines. Typical examples are condensation products of the abovementioned fatty acids with AEEA, preferably imidazolines based on lauric acid or again C_{12/14} coconut fatty acid, which are subsequently betainized with sodium chloroacetate.

Builders

In a further preferred embodiment of the invention, the tablets may contain builder substances, for example, in amounts of from 5 to 50% and preferably from 10 to 35% by weight based on the tablets. The finely crystalline, synthetic zeolite frequently used as a laundry detergent builder, containing bound water, is preferably zeolite A and/or P. An example of a particularly preferred zeolite P is zeolite MAP(R) (commercial product from Crosfield). Also suitable, however, are zeolite X and also mixtures of A, X and/or P and also Y. Also of particular interest is a cocrystallized sodium/potassium aluminum silicate comprising zeolite A and zeolite X, which is available commercially as VEGOBOND AX® (commercial product from Condea Augusta S.p.A.). The zeolite may be employed in the form of spray-dried powder or else as an undried (still wet from its preparation), stabilized suspension. Where the zeolite is used in suspension form, said suspension may include small additions of nonionic surfactants as stabilizers: for example, from 1 to 3% by weight, based on zeolite, of ethoxylated C₁₂-C₁₈ fatty alcohols having from 2 to 5 ethylene oxide groups, C₁₂-C₁₄ fatty alcohols having from 4 to 5 ethylene oxide groups or ethoxylated isotridecanols. Suitable zeolites have an average particle size of less than 10 μm (volume distribution; measurement method: Coulter counter) and contain preferably from 18 to 22% by weight, in particular from 20 to 22% by weight, of bound water.

Suitable substitutes or partial substitutes for phosphates and zeolites are crystalline, layered sodium silicates of the general formula NaMSiₓO₂ₓ₊₁.yH₂O, where M is sodium or hydrogen, x is a number from 1.9 to 4, y is a number from 0 to 20, and preferred values for x are 2, 3 or 4. Crystalline phyllosilicates of this kind are described, for example, in the European patent application EP 0164514 A1. Preferred crystalline phyllosilicates of the formula indicated are those in which M is sodium and x adopts the value 2 or 3. In particular, both β- and δ-sodium disilicates Na₂Si₂O₅.yH₂O are preferred, β-sodium disilicate, for example, being obtainable by the process described in the inter-national patent application WO 91/08171. Further suitable phyllosilicates are known, for example, from the patent applications DE 2334899 A1, EP 0026529 A1 and DE 3526405 A1. Their usefulness is not restricted to a specific composition or structural formula. However, preference is given here to smectites, especially bentonites. Suitable phyllosilicates which belong to the group of the water-swellable smectites include, for example, those of the general formulae

(OH)₄Si_{8-y}Al_{y}(MgₓAl₄₋ₓ)O₂₀ montmorillonite

(OH)₄Si_{8-y}Al_{y}(Mg_{6-z}Li_{z})O₂₀ hectorite

(OH)₄Si_{8-y}Al_{y}(Mg_{6-z}Al_{z})O₂₀ saponite

where x=0 to 4, y=0 to 2, z=0 to 6. Moreover, small amounts of iron may be incorporated into the crystal lattice of the phyllosilicates in accordance with the above formulae. Moreover, on the basis of their ion exchange properties, the phyllosilicates may contain hydrogen, alkali metal and/or alkaline earth metal ions, especially Na⁺ and Ca²⁺. The amount of water in hydrate form is generally in the range from 8 to 20% by weight and is dependent on the state of swelling and/or on the nature of processing. Phyllosilicates which can be used are known, for example, from U.S. Pat. No. 3,966,629, U.S. Pat. No. 4,062,647, EP 0026529 A1 and EP 0028432 A1. It is preferred to use phyllosilicates which owing to an alkali treatment are substantially free of calcium ions and strongly coloring iron ions. The preferred builder substances also include amorphous sodium silicates having an Na₂O:SiO₂ modulus of from 1:2 to 1:3.3, preferably from 1:2 to 1:2.8, and in particular from 1:2 to 1:2.6, which are dissolution-retarded and have secondary washing properties. The retardation of dissolution relative to conventional amorphous sodium silicates may have been brought about in a variety of ways; for example, by surface treatment, compounding, compacting, or overdrying. In the context of this invention, the term “amorphous” also embraces “X-ray-amorphous”. This means that, in X-ray diffraction experiments, the silicates do not yield the sharp X-ray reflections typical of crystalline substances but instead yield at best one or more maxima of the scattered X-radiation, having a width of several degree units of the diffraction angle. However, good builder properties may result, even particularly good builder properties, if the silicate particles in electron diffraction experiments yield vague or even sharp diffraction maxima. The interpretation of this is that the products have microcrystalline regions with a size of from 10 to several hundred nm, values up to max. 50 nm and in particular up to max. 20 nm being preferred. So-called X-ray-amorphous silicates of this kind, which likewise possess retarded dissolution relative to the conventional waterglasses, are described, for example, in the German patent application DE 4400024 A1. Particular preference is given to compacted amorphous silicates, compounded amorphous silicates, and overdried X-ray-amorphous silicates.

It is of course also possible to use the widely known phosphates as builder substances, provided such a use is not to be avoided on ecological grounds. Particularly suitable phosphates are the sodium salts of the orthophosphates, of the pyrophosphates and, in particular, of the tripolyphosphates. Their amount should generally be not more than 25% by weight, preferably not more than 20% by weight, based in each case on the finished composition. In certain cases it has been found that tripolyphosphates in particular, even in small amounts up to not more than 10% by weight, based on the finished composition, lead in combination with other builder substances to a synergistic improvement in the secondary detergency.

Useful organic builder substances suitable as cobuilders are, for example, the polycarboxylic acids, which can be used in the form of their sodium salts, such as citric acid, adipic acid, succinic acid, glutaric acid, tartaric acid, sugar acids, amino carboxylic acids, nitrilotriacetic acid (NTA), provided such use is not objectionable on ecological grounds, and also mixtures of these. Preferred salts are the salts of the polycarboxylic acids such as citric acid, adipic acid, succinic acid, glutaric acid, tartaric acid, sugar acids, and mixtures thereof. The acids per se may also be used. In addition to their builder effect, the acids typically also possess the property of an acidifying component and thus also serve to establish a lower and milder pH of laundry detergents or cleaning products. In this context, mention may be made in particular of citric acid, succinic acid, glutaric acid, adipic acid, gluconic acid, and any desired mixtures thereof.

Further suitable organic builder substances are dextrins, examples being oligomers and polymers of carbohydrates, which may be obtained by partial hydrolysis of starches. The hydrolysis may be conducted by customary processes, examples being acid-catalyzed or enzyme-catalyzed processes. The hydrolysis products preferably have average molar masses in the range from 400 to 500 000. Preference is given here to a polysaccharide having a dextrose equivalent (DE) in the range from 0.5 to 40, in particular from 2 to 30, DE being a common measure of the reducing effect of a polysaccharide in comparison to dextrose, which possesses a DE of 100. It is possible to use both maltodextrins having a DE of between 3 and 20 and dry glucose syrups having a DE of between 20 and 37, and also so-called yellow dextrins and white dextrins having higher molar masses, in the range from 2 000 to 30 000. One preferred dextrin is described in the British patent application GB 9419091 Al. The oxidized derivatives of such dextrins comprise their products of reaction with oxidizing agents which are able to oxidize at least one alcohol function of the saccharide ring to the carboxylic acid function. Oxidized dextrins of this kind, and processes for preparing them, are known, for example, from the European patent applications EP 0232202 A1, EP 0427349 A1, EP 0472042 A1 and EP 0542496 A1 and from the international patent applications WO 92/18542, WO 93/08251, WO 93/16110, WO 94/28030, WO 95/07303, WO 95/12619 and WO 95/20608. Likewise suitable is an oxidized oligosaccharide in accordance with the German patent application DE 19600018 A1. A product oxidized at C₆ of the saccharide ring may be particularly advantageous.

Further suitable cobuilders are oxydisuccinates and other derivatives of disuccinates, preferably ethylenediamine disuccinate. Particular preference is given in this context as well to glycerol disuccinates and glycerol trisuccinates, as described for example in the US patents U.S. Pat. No. 4,524,009, U.S. Pat. No. 4,639,325, in the European patent application EP 0150930 A1 and in the Japanese patent application JP 93/339896. Suitable use amounts in formulations containing zeolite and/or silicate are from 3 to 15% by weight.

Further organic cobuilders which can be used are, for example, acetylated hydroxycarboxylic acids and/or their salts, which may also be present, where appropriate, in lactone form and which contain at least 4 carbon atoms and at least one hydroxyl group and also not more than two acid groups. Cobuilders of this kind are described, for example, in the international patent application WO 95/20029.

Suitable polymeric polycarboxylates are, for example, the sodium salts of polyacrylic acid or of polymethacrylic acid, examples being those having a relative molecular mass of from 800 to 150 000 (based on acid and in each case measured against polystyrenesulfonic acid). Particularly suitable copolymeric polycarboxylates are those of acrylic acid with methacrylic acid and of acrylic acid or methacrylic acid with maleic acid. Copolymers of acrylic acid with maleic acid, containing from 50 to 90% by weight acrylic acid and from 50 to 10% by weight maleic acid, have proven particularly suitable. Their relative molecular mass, based on free acids, is generally from 5 000 to 200 000, preferably from 10 000 to 120 000, and in particular from 50 000 to 100 000 (measured in each case against polystyrenesulfonic acid). The (co)polymeric polycarboxylates may be used either as powders or in the form of an aqueous solution, in which case preference is given to aqueous solutions with a strength of from 20 to 55% by weight. Granular polymers are generally admixed subsequently to one or more base granules. Particular preference is also given to biodegradable polymers made up of more than two different monomer units, examples being those in accordance with DE 4300772 A1, containing as monomers salts of acrylic acid and of maleic acid and also vinyl alcohol and/or vinyl alcohol derivatives, or those in accordance with DE 4221381 C2, containing as monomers salts of acrylic acid and of 2-alkylallylsulfonic acid and also sugar derivatives. Preferred also as copolymers are those which are described in the German patent applications DE 4303320 A1 and DE 4417734 A1 and which as monomers comprise preferably acrolein and acrylic acid/acrylic acid salts or acrolein and vinyl acetate. Further preferred builder substances include polymeric amino dicarboxylic acids, their salts or their precursors. Particular preference is given to polyaspartic acids and their salts and derivatives.

Further suitable builder substances are polyacetals, which may be obtained by reacting dialdehydes with polyolcarboxylic acids having from 5 to 7 carbon atoms and at least 3 hydroxyl groups, as described for example in the European patent application EP 0280223 A1. Preferred polyacetals are obtained from dialdehydes such as glyoxal, glutaraldehyde, terephthalaldehyde and mixtures thereof and from polyolcarboxylic acids such as gluconic acid and/or glucoheptonic acid.

Disintegrants

As further ingredients in a third preferred embodiment, finally, the tablets may comprise disintegrants. These are substances which are added to the tablets in order to accelerate their breakdown when they are brought into contact with water. Overviews of this subject can be found, for example, in J. Pharm. Sci. 61 (1972), Rompp Chemilexikon, 9th edition, volume 6, p. 4440, and Voigt “Lehrbuch der pharmazeutischen Technologie” (6^{th} Edition, 1987, pp. 182-184). These substances increase in volume on ingress of water, where on the one hand the intrinsic volume can be increased (swelling) and, on the other hand, by the evolution of gases, a pressure can be produced which causes the tablet to break down into smaller particles. Examples of established disintegration aids are carbonate/citric acid systems, although other organic acids may also be used. Examples of swelling disintegration aids are synthetic polymers such as polyvinylpyrrolidone (PVP) or natural polymers or else modified natural substances such as cellulose and starch and their derivatives, alginates or casein derivatives. Preferred disintegrants used in the context of the present invention are cellulose-based distintegrants. Pure cellulose has the formal empirical composition (C₆H₁₀O₅)ₙ and, considered formally, is a β-1,4-polyacetal of cellobiose, which itself is constructed of two molecules of glucose. Suitable celluloses consist of from about 500 to 5 000 glucose units and, accordingly, have average molecular masses of from 50 000 to 500 000. Cellulose-based disintegrants which can be used also include, in the context of the present invention, cellulose derivatives obtainable from cellulose by polymer-analogous reactions. Such chemically modified celluloses include, for example, products of esterifications and etherifications in which hydroxy hydrogen atoms have been substituted. However, celluloses in which the hydroxyl groups have been replaced by functional groups not attached via an oxygen atom may also be used as cellulose derivatives. The group of the cellulose derivatives also embraces, for example, alkali metal celluloses, carboxymethyl-cellulose (CMC), cellulose esters and cellulose ethers, and aminocelluloses. Said cellulose derivatives are preferably not used alone as cellulose-based disintegrants but instead are used in a mixture with cellulose. The cellulose derivative content of these mixtures is preferably less than 50% by weight, with particular preference less than 20% by weight, based on the cellulose-based disintegrant. A particularly preferred cellulose-based disintegrant used is pure cellulose, free from cellulose derivatives. As a further cellulose-based disintegrant or as a constituent of this component it is possible to use microcrystalline cellulose. This microcrystalline cellulose is obtained by partial hydrolysis of celluloses under conditions which attack only the amorphous regions (approximately 30% of the total cellulose mass) of the celluloses and break them up completely but leave the crystalline regions (approximately 70%) intact. Subsequent deaggregation of the microfine celluloses resulting from the hydrolysis yields the microcrystalline celluloses, which have primary particle sizes of approximately 5 μm and may be compacted, for example, to granules having an average particle size of 200 μm. Within the tablet, viewed macroscopically, the disintegrants may be in homogeneous distribution, but viewed microscopically, as a result of the preparation process, they form zones of increased concentration. Disintegrants which may be present in the context of the invention, such as Kollidon, alginic acid and the alkali metal salts thereof, amorphous or else partly crystalline phyllosilicates (bentonites), polyacrylates, poly-ethylene glycols can be found, for example, in the documents WO 98/40462 (Rettenmaier), WO 98/55583, and WO 98/55590 (Unilever) and WO 98/40463, DE 19709991, and DE 19710254 A1 (Henkel). The teaching of these documents is expressly incorporated by reference. The tablets may contain the disintegrants in amounts of from 0.1 to 25%, preferably from 1 to 20%, and in particular from 5 to 15% by weight based on the tablets.

Tableting

Tablets with laundry detergent and cleaning activity are produced by applying pressure to a mixture for compression which is present in the cavity of a press. At its most simple, tablet production, referred to hereinbelow simply as tableting, involves compressing the mixture to be tableted directly, i.e., without granulating beforehand. The advantages of this technique known as direct tableting are its simple and cost-effective application, since no further process steps and thus no further equipment are needed. These advantages, however, are confronted by disadvantages as well. For instance, a powder mixture which is to be tableted directly is required to possess a sufficient plastic deformability and to have good flow properties, and it must also not display any tendencies toward separation during storage, transport, and filling of the die. With many mixtures of substances, these three preconditions are extremely difficult to manage, with the consequence that direct tableting is not employed very often, especially in the production of laundry detergent and cleaning product tablets. The normal route to the production of laundry detergent and cleaning product tablets therefore starts from pulverulent components (“primary particles”) which are agglomerated or granulated to secondary particles of greater diameter by means of appropriate techniques. These granules or mixtures of different granules are then combined with individual pulverulent adjuvants and that mixture is passed on for tableting. Laundry detergent and cleaning product tablets which are preferred in the context of the present invention are obtained by compressing a particulate premix composed of at least one kind of surfactant granules and at least one subsequently admixed pulverulent component. For the subsequent laundry detergent and cleaning product tablets it is of advantage if the premix for compression has a bulk density which comes close to that of conventional compact laundry detergents. In particular it is preferred for the premix to be compressed to have a bulk density of at least 500 g/l, preferably at least 600 g/l, and in particular more than 700 g/l. Prior to the compression of the particulate premix to give laundry detergent and cleaning product tablets, the premix may be “powdered” with finely divided surface treatment agents. This may be of advantage for the quality and physical properties both of the premix (storage, compression) and of the finished laundry detergent and cleaning product tablets. Finely divided powdering agents are very well known in the prior art, use being made mostly of zeolites, silicates or other inorganic salts. Preferably, however, the premix is “powdered” with finely divided zeolite, with preference being given to zeolites of the faujasite type. In the context of the present invention, the term “zeolite of the faujasite type” characterizes all three zeolites which form the faujasite subgroup of zeolite structural group 4 (compare Donald W. Breck: “Zeolite Molecular Sieves”, John Wiley & Sons, New York, London, Sydney, Toronto, 1974, page 92). Besides zeolite X, therefore, zeolite Y and faujasite can also be used, and also mixtures of these compounds, with preference being given to zeolite X on its own. Mixtures or cocrystallizates of zeolites of the faujasite type with other zeolites, which need not necessarily belong to zeolite structural group 4, can also be used as powdering agents, it being of advantage if at least 50% by weight of the powdering agent are composed of a zeolite of the faujasite type. In the context of the present invention, preference is given to laundry detergent and cleaning product tablets composed of a particulate premix that comprises granular components and subsequently admixed pulverulent substances, the (or one of the) subsequently admixed pulverulent components being a zeolite of the faujasite type of particle sizes less than 100 μm, preferably less than 10 μm, and in particular less than 5 μm, and making up at least 0.2% by weight, preferably at least 0.5% by weight, and in particular more than 1% by weight of the premix for compression. In the preferred embodiment of the invention the shaped bodies in tablet form have edges and angles which are preferably rounded off for reasons in particular associated with storage and transit. The base area of these tablets may, for example, be circular or rectangular. Multilayer tablets, especially tablets with 2 or 3 layers, which may also be different in color, are preferred in particular. Blue-white or green-white or blue-green-white tablets are especially preferred. The tablets may also comprise pressed and unpressed portions. Tablets with a particularly advantageous dissolution rate are obtained if the granular constituents prior to compression possess a fraction of less than 20%, preferably less than 10%, by weight of particles which possess a diameter outside of the range from 0.02 to 6 mm. Preference is given to a particle size distribution in the range from 0.05 to 2.0 and, with particular preference, from 0.2 to 1.0 mm.

Commercial Applicability

Besides the abovementioned ingredients—surfactant, builder, and disintegration aids—the laundry detergent and cleaning product tablets of the invention may comprise further ingredients which are customary in laundry detergents and cleaning products and are selected from the group consisting of bleaches, bleach activators, enzymes, fragrances, perfume carriers, fluorescents, dyes, foam inhibitors, silicone oils, antiredeposition agents, optical brighteners, graying inhibitors, color transfer inhibitors, and corrosion inhibitors.

Bleaches and Bleach Activators

Among the compounds used as bleaches which yield H₂O₂ in water, particular importance is possessed by sodium perborate tetrahydrate and sodium perborate monohydrate. Further bleaches which may be used are, for example, sodium percarbonate, peroxypyrophosphates, citrate perhydrates, and H₂O₂-donating peracidic salts or peracids, such as perbenzoates, peroxophthalates, diperazelaic acid, phthaloiminoperoxy acid or diperdodecanedioic acid. The bleach content of the compositions is preferably from 5 to 35% by weight and in particular up to 30% by weight, use being made advantageously of perborate monohydrate or percarbonate.

Bleach activators which may be used are compounds which under perhydrolysis conditions give rise to aliphatic peroxocarboxylic acids having preferably from 1 to 10 carbon atoms, in particular from 2 to 4 carbon atoms, and/or unsubstituted or substituted perbenzoic acid. Suitable substances are those which carry O-acyl and/or N-acyl groups of the stated number of carbon atoms, and/or substituted or unsubstituted benzoyl groups. Preference is given to polyacylated alkylenediamines, especially tetraacetylethylenediamine (TAED), acylated triazine derivatives, especially 1,5-diacetyl-2,4-dioxohexahydro-1,3,5-triazine (DADHT), acylated glycolurils, especially tetraacetylglycoluril (TAGU), N-acyl imides, especially N-nonanoylsuccinimide (NOSI), acylated phenolsulfonates, especially n-nonanoyl- or isononanoyloxybenzenesulfonate (n- or iso-NOBS), carboxylic anhydrides, especially phthalic anhydride, acylated polyhydric alcohols, especially triacetin, ethylene glycol diacetate, 2,5-diacetoxy-2,5-dihydrofuran, and the enol esters known from the German patent applications DE 19616693 A1 and DE 19616767 A1, and also acetylated sorbitol and mannitol and/or mixtures thereof (SORMAN) described in the European patent application EP 0525239 A1, acylated sugar derivatives, especially pentaacetylglucose (PAG), pentaacetylfructose, tetraacetylxylose and octaacetyllactose, and also acetylated, optionally N-alkylated glucamine and gluconolactone, and/or N-acylated lactams, an example being N-benzoyl caprolactam, which are known from the international patent applications Wo 94/27970, WO 94/28012, WO 94/28103, WO 95/00626, WO 95/14759 and WO 95/17498. The hydrophilically substituted acyl acetals known from the German patent application DE 19616769 Al and the acyl lactams described in the German patent application DE 19616770 and also in the international patent application WO 95/14075 are likewise used with preference. It is also possible to use the combinations of conventional bleach activators known from the German patent application DE 4443177 A1. Bleach activators of this kind are present in the customary quantity range, preferably in amounts of from 1% by weight to 10% by weight, in particular from 2% by weight to 8% by weight, based on overall composition. In addition to the abovementioned conventional bleach activators, or instead of them, it is also possible for the bleach-boosting transition metal salts and/or transition metal complexes and/or sulfone imines known from the European patents EP 0446982 B1 and EP 0453003 B1 to be present as so-called bleaching catalysts. The transition metal compounds in question include in particular those manganese, iron, cobalt, ruthenium or molybdenum salen complexes known from the German patent application DE 19529905 A1, and their N-analog compounds known from the German patent application DE 19620267 A1; the manganese, iron, cobalt, ruthenium or molybdenum carbonyl complexes known from the German patent application DE 19536082 A1; the manganese, iron, cobalt, ruthenium, molybdenum, titanium, vanadium and copper complexes with nitrogen-containing tripod ligands that are described in the German patent application DE 196 05 688 A1; the cobalt, iron, copper and ruthenium amine complexes known from the German patent application DE 19620411 A1; the manganese, copper and cobalt complexes described in the German patent application DE 4416438 Al; the cobalt complexes described in the European patent application EP 0272030 A1; the manganese complexes known from the European patent application EP 0693550 A1; the manganese, iron, cobalt and copper complexes known from the European patent EP 0392592 A1; and/or the manganese complexes described in the European patent EP 0443651 B1 or in the European patent applications EP 0458397 A1, EP 0458398 A1, EP 0549271 A1, EP 0549272 A1, EP 0544490 A1 and EP 0544519 A1. Combinations of bleach activators and transition metal bleaching catalysts are known, for example, from the German patent application DE 19613103 A1 and from the international patent application WO 95/27775. Bleach-boosting transition metal complexes, especially those with the central atoms Mn, Fe, Co, Cu, Mo, V, Ti and/or Ru, are employed in customary amounts, preferably in an amount of up to 1% by weight, in particular from 0.0025% by weight to 0.25% by weight, and with particular preference from 0.01% by weight to 0.1% by weight, based in each case on the total composition.

Enzymes and Enzyme Stabilizers

Particularly suitable enzymes include those from the class of the hydrolases, such as the proteases, esterases, lipases or lipolytic enzymes, amylases, cellulases or other glycosyl hydrolases, and mixtures of the stated enzymes. All of these hydrolases contribute in the wash to removing stains, such as proteinaceous, fatty or starchy stains, and instances of graying. Cellulases and other glycosyl hydrolases may, by removing pilling and microfibrils, make a contribution to color retention and to enhancing the softness of the textile. For bleaching and/or for inhibiting dye transfer it is also possible to use oxidoreductases. Especially suitable active enzymatic substances are those obtained from bacterial strains or fungi, such as Bacillus subtilis, Bacillus licheniformis, Streptomyces griseus, and Humicola insolens. It is preferred to use proteases of the subtilisin type, and especially proteases obtained from Bacillus lentus. Of particular interest in this context are enzyme mixtures, examples being those of protease and amylase or protease and lipase or lipolytic enzymes, or protease and cellulase, or of cellulase and lipase or lipolytic enzymes, or of protease, amylase and lipase or lipolytic enzymes, or protease, lipase or lipolytic enzymes and cellulase, but especially mixtures containing protease and/or lipase, or mixtures containing lipolytic enzymes. Examples of such lipolytic enzymes are the known cutinases. Peroxidases or oxidases have also proven suitable in some cases. The suitable amylases include, in particular, α-amylases, isoamylases, pullulanases, and pectinases. Cellulases used are preferably cellobiohydrolases, endoglucanases and β-glucosidases, also referred to as cellobiases, and mixtures of these. Since the different cellulase types differ in their CMCase and Avicelase activities, the desired activities may be established by means of targeted mixtures of the cellulases. The enzymes may be adsorbed on carrier substances and/or embedded in coating substances in order to protect them against premature decomposition. The fraction of the enzymes, enzyme mixtures or enzyme granules may be, for example, from about 0.1 to 5% by weight, preferably from 0.1 to about 2% by weight.

In addition to the monofunctional and polyfunctional alcohols, the compositions may comprise further enzyme stabilizers. For example, from 0.5 to 1% by weight of sodium formate may be used. Also possible is the use of proteases stabilized with soluble calcium salts, with a calcium content of preferably about 1.2% by weight, based on the enzyme. Besides calcium salts, magnesium salts also serve as stabilizers. However, it is particularly advantageous to employ boron compounds, examples being boric acid, boron oxide, borax and other alkali metal borates such as the salts of orthoboric acid (H₃BO₃), of metaboric acid (HBO₂), and of pyroboric acid (tetraboric acid, H₂B₄O₇).

Graying Inhibitors

Graying inhibitors have the function of keeping the soil detached from the fiber in suspension in the liquor and so preventing the reattachment of the soil. Suitable for this purpose are water-soluble colloids, usually organic in nature, examples being the water-soluble salts of polymeric carboxylic acids, glue, gelatin, salts of ether carboxylic acids or ether sulfonic acids of starch or of cellulose, or salts of acidic sulfuric esters of cellulose or of starch. Water-soluble polyamides containing acidic groups are also suitable for this purpose. Furthermore, use may be made of soluble starch preparations and starch products other than those mentioned above, examples being degraded starch, aldehyde starches, etc. Polyvinylpyrrolidone as well can be used. However, it is preferred to use celluose ethers, such as carboxymethylcellulose (Na salt), methylcellulose, hydroxyalkylcellulose, and mixed ethers, such as methylhydroxyethylcellulose, methylhydroxypropylcellulose, methylcarboxymethylcellulose and mixtures thereof, and also polyvinylpyrrolidone, for example, in amounts of from 0.1 to 5% by weight, based on the compositions.

Optical Brighteners

As optical brighteners the compositions may comprise derivatives of diaminostilbenedisulfonic acid and/or alkali metal salts thereof. Suitable, for example, are salts of 4,4′-bis(2-anilino-4-morpholino-1,3,5-triazinyl-6-amino)stilbene-2,2′-disulfonic acid or compounds of similar structure which instead of the morpholino group carry a diethanolamino group, a methylamino group, an anilino group, or a 2-methoxyethylamino group. It is possible for brighteners of the substituted diphenylstyryl type to be present, examples being the alkali metal salts of 4,4′-bis(2-sulfostyryl)biphenyl, 4,4′-bis(4-chloro-3-sulfostyryl)-biphenyl or 4-(4-chlorostyryl)-4′-(2-sulfostyryl)biphenyl. Mixtures of the aforementioned brighteners may also be used. Uniformly white granules are obtained if, in addition to the customary brighteners in customary amounts, examples being between 0.1 and 0.5% by weight, preferably between 0.1 and 0.3% by weight, the compositions also include small amounts, examples being from 10⁻⁶ to 10⁻³% by weight, preferably around 10⁻⁵% by weight, of a blue dye. One particularly preferred dye is Tinolux® (commercial product from Ciba-Geigy).

Polymers

Suitable dirt-repelling polymers (soil repellents) include those substances which preferably contain ethylene terephthalate and/or polyethylene glycol terephthalate groups, it being possible for the molar ratio of ethylene terephthalate to polyethylene glycol terephthalate to be situated within the range from 50:50 to 90:10. The molecular weight of the linking polyethylene glycol units is situated in particular in the range from 750 to 5 000, i.e., the degree of ethoxylation of the polymers containing polyethylene glycol groups can be from about 15 to 100. The polymers feature an average molecular weight of about 5 000 to 200 000 and may have a block structure, though preferably have a random strucure. Preferred polymers are those having ethylene terephthalate/polyethylene glycol terephthalate molar ratios of from about 65:35 to about 90:10, preferably from about 70:30 to 80:20. Preference is also given to those polymers which have linking polyethylene glycol units with a molecular weight of from 750 to 5 000, preferably from 1 000 to about 3 000, and with a molecular weight of the polymer of from about 10 000 to about 50 000. Examples of commercial polymers are the products Milease® T (ICI) or Repelotex® SRP 3 (Rhône-Poulenc).

Defoamers

As defoamers it is possible to use waxlike compounds. “Waxlike” compounds are those whose melting point at atmospheric pressure is more than 25° C. (room temperature), preferably more than 50° C., and in particular more than 70° C. The waxlike defoamer substances are virtually insoluble in water; that is, at 20° C. they have a solubility in 100 g of water of below 0.1% by weight. In principle, any of the waxlike defoamer substances known from the prior art may be included. Examples of suitable waxlike compounds are bisamides, fatty alcohols, fatty acids, carboxylic acid esters of monohydric and polyhydric alcohols, and also paraffin waxes, or mixtures thereof. An alternative possibility is of course to use the silicone compounds which are known for this purpose.

Suitable paraffin waxes generally constitute a complex substance mixture without a defined melting point. The mixture is normally characterized by determining its melting range using differential thermal analysis (DTA), as described in The Analyst 87 (1962), 420, and/or its solidification point. The solidification point is the temperature at which the paraffin, by slow cooling, undergoes transition from the liquid to the solid state. Paraffins which are completely liquid at room temperature, i.e., those having a solidification point below 25° C., cannot be used in accordance with the invention. The soft waxes, having a melting point in the range from 35 to 50° C., include preferably the group of the petrolatums and their hydrogenation products. They are composed of microcrystalline paraffins and up to 70% by weight of oil, possess an ointmentlike to plastically solid consistency, and constitute bitumen-free residues from petroleum processing. Particular preference is given to distillation residues (petrolatum stock) of certain paraffin-base and mixed-base crude oils, which are processed further into Vaseline. Such products further comprise bitumen-free, oleaginous to solid hydrocarbons deposited by means of solvent from distillation residues of paraffin-base and mixed-base crude oils and cylinder oil distillates. They are of semisolid, viscous, tacky or plastically solid consistency and possess melting points of between 50 and 70° C. These petrolatums constitute the major starting point for the preparation of microwaxes. Also suitable are the solid hydrocarbons, with melting points between 63 and 79° C., which are deposited from high-viscosity, paraffin-containing lubricating oil distillates in the course of dewaxing. These petrolatums comprise mixtures of microcrystalline waxes and high-melting n-paraffins. It is possible to use, for example, the paraffin wax mixtures known from EP 0309931 A1, made up for example of from 26% by weight to 49% by weight of microcrystalline paraffin wax having a solidification point of from 62° C. to 90° C., from 20% by weight to 49% by weight of hard paraffin with a solidification point of from 42° C. to 56° C., and from 2% by weight to 25% by weight of soft paraffin having a solidification point of from 35° C. to 40° C. It is preferred to use paraffins or paraffin mixtures which solidify in the range from 30° C. to 90° C. It needs to be borne in mind here that even paraffin wax mixtures which appear solid at room temperature may include various fractions of liquid paraffin. In the case of the paraffin waxes suitable for use in accordance with the invention, this liquid fraction is as low as possible and is preferably absent entirely. Accordingly, particularly preferred paraffin wax mixtures have a liquid fraction at 30° C. of less than 10% by weight, in particular from 2% by weight to 5% by weight, a liquid fraction at 40° C. of less than 30% by weight, preferably from 5% by weight to 25% by weight, and in particular from 5% by weight to 15% by weight, a liquid fraction at 60° C. of from 30% by weight to 60% by weight, in particular from 40% by weight to 55% by weight, a liquid fraction at 80° C. of from 80% by weight to 100% by weight, and a liquid fraction at 90° C. of 100% by weight. In the case of particularly preferred paraffin wax mixtures, the temperature at which a liquid fraction of 100% by weight of the paraffin wax is attained is still below 85° C., in particular at from 75° C. to 82° C. The paraffin waxes may comprise petrolatum, micro-crystalline waxes, and hydrogenated or partially hydrogenated paraffin waxes.

Appropriate bisamide defoamers are those deriving from saturated fatty acids having from 12 to 22, preferably from 14 to 18 carbon atoms, and from alkylenediamines having from 2 to 7 carbon atoms. Suitable fatty acids are lauric, myristic, stearic, arachic and behenic acid and mixtures thereof, such as are obtainable from natural fats and/or hydrogenated oils, such as tallow or hydrogenated palm oil. Examples of suitable diamines are ethylenediamine, 1,3-propylenediamine, tetramethylenediamine, pentamethylenediamine, hexamethylenediamine, p-phenylenediamine, and tolylenediamine. Preferred diamines are ethylenediamine and hexamethylenediamine. Particularly preferred bisamides are bismyristoylethylenediamine, bispalmitoylethylenediamine, bisstearoylethylenediamine, and mixtures thereof, and also the corresponding derivatives of hexamethylenediamine.

Suitable carboxylic ester defoamers derive from carboxylic acids having from 12 to 28 carbon atoms. The esters in question particularly include those of behenic acid, stearic acid, hydroxystearic acid, oleic acid, palmitic acid, myristic acid and/or lauric acid. The alcohol moiety of the carboxylic ester comprises a monohydric or polyhydric alcohol having from 1 to 28 carbon atoms in the hydrocarbon chain. Examples of suitable alcohols are behenyl alcohol, arachidyl alcohol, cocoyl alcohol, 12-hydroxystearyl alcohol, oleyl alcohol, and lauryl alcohol, and also ethylene glycol, glycerol, polyvinyl alcohol, sucrose, erythritol, pentaerythritol, sorbitan and/or sorbitol. Preferred esters are those of ethylene glycol, glycerol, and sorbitan, the acid moiety of the ester being selected in particular from behenic acid, stearic acid, oleic acid, palmitic acid or myristic acid. Suitable esters of polyhydric alcohols are, for example, xylitol monopalmitate, pentaerythritol monostearate, glycerol monostearate, ethylene glycol monostearate, and sorbitan monostearate, sorbitan palmitate, sorbitan monolaurate, sorbitan dilaurate, sorbitan distearate, sorbitan dibehenate, sorbitan dioleate, and also mixed tallow alkyl sorbitan monoesters and diesters. Glycerol esters which can be used are the mono-, di- or triesters of glycerol and the carboxylic acids mentioned, with the monoesters or diesters being preferred. Glycerol monostearate, glycerol monooleate, glycerol monopalmitate, glycerol monobehenate, and glycerol distearate are examples thereof. Examples of suitable natural ester defoamers are beeswax, which consists principally of the esters CH₃ (CH₂)₂₄COO(CH₂)₂₇CH₃ and CH₃ (CH₂)₂₆COO(CH₂) 25CH₃, and carnauba wax, which is a mixture of carnaubic acid alkyl esters, often in combination with small fractions of free carnaubic acid, further long-chain acids, high molecular mass alcohols and hydrocarbons.

Suitable carboxylic acids as further defoamer compounds are particularly behenic acid, stearic acid, oleic acid, palmitic acid, myristic acid, and lauric acid, and also mixtures thereof, such as are obtainable from natural fats and/or optionally hydrogenated oils, such as tallow or hydrogenated palm oil. Preference is given to saturated fatty acids having from 12 to 22, in particular from 18 to 22, carbon atoms.

Suitable fatty alcohols as further defoamer compounds are the hydrogenated products of the fatty acids described.

Furthermore, dialkyl ethers may additionally be present as defoamers. The ethers may be asymmetrical or else symmetrical in composition, i.e., contain two identical or different alkyl chains, preferably with from 8 to 18 carbon atoms. Typical examples are di-n-octyl ether, diisooctyl ether and di-n-stearyl ether; particularly suitable are dialkyl ethers having a melting point of more than 25° C., in particular more than 40° C.

Further suitable defoamer compounds are fatty ketones, which may be obtained by the relevant methods of preparative organic chemistry. They are prepared, for example, starting from carboxylic acid magnesium salts, which are pyrolyzed at temperatures above 300° C. with elimination of carbon dioxide and water, in accordance for example with the German laid-open specification DE 2553900 A. Suitable fatty ketones are those prepared by pyrolyzing the magnesium salts of lauric acid, myristic acid, palmitic acid, palmitoleic acid, stearic acid, oleic acid, elaidic acid, petroselinic acid, arachic acid, gadoleic acid, behenic acid or erucic acid.

Further suitable defoamers are fatty acid polyethylene glycol esters, which are obtained preferably by homogeneous base-catalyzed addition reaction of ethylene oxide with fatty acids. In particular, the addition reaction of ethylene oxide with the fatty acids takes place in the presence of alkanolamine catalysts. The use of alkanolamines, especially triethanolamine, leads to extremely selective ethoxylation of the fatty acids, especially where the aim is to prepare compounds with low degrees of ethoxylation. Within the group of the fatty acid polyethylene glycol esters, preference is given to those having a melting point of more than 25° C., in particular more than 40° C. Within the group of the waxlike defoamers, particular preference is given to using the above-described paraffin waxes as sole waxlike defoamers or in a mixture with one of the other waxlike defoamers, the fraction of the paraffin waxes in the mixture accounting preferably for more than 50% by weight, based on the waxlike defoamer mixture. Where appropriate, the paraffin waxes may have been applied to carriers. Suitable carrier materials include all known inorganic and/or organic carrier materials. Examples of typical inorganic carrier materials are alkali metal carbonates, aluminosilicates, water-soluble phyllosilicates, alkali metal silicates, alkali metal sulfates, an example being sodium sulfate, and alkali metal phosphates. The alkali metal silicates preferably comprise a compound having an alkali metal oxide to SiO₂ molar ratio of from 1:1.5 to 1:3.5. The use of such silicates results in especially good particle properties; in particular, high abrasion stability and yet high dissolution rate in water. The aluminosilicates referred to as carrier materials include in particular the zeolites, examples being zeolite NaA and NaX. The compounds referred to as water-soluble phyllosilicates include, for example, amorphous or crystalline waterglass. It is also possible to use silicates which are in commerce under the designation Aerosil® or Sipernat®. As organic carrier materials, suitable examples include film-forming polymers, examples being polyvinyl alcohols, polyvinylpyrrolidones, poly (meth)acrylates, polycarboxylates, cellulose derivatives, and starch. Cellulose ethers that may be used are, in particular, alkali metal carboxymethylcellulose, methylcellulose, ethylcellulose, hydroxyethylcellulose, and what are known as cellulose mixed ethers, examples being methylhydroxyethylcellulose and methylhydroxypropylcellulose, and also mixtures thereof. Particularly suitable mixtures are composed of sodium carboxymethylcellulose and methylcellulose, the carboxymethylcellulose usually having a degree of substitution of from 0.5 to 0.8 carboxymethyl groups per anhydroglucose unit and the methylcellulose having a degree of substitution of from 1.2 to 2 methyl groups per anhydroglucose unit. The mixtures preferably comprise alkali metal carboxymethylcellulose and nonionic cellulose ethers in weight proportions of from 80:20 to 40:60, in particular from 75:25 to 50:50. Another suitable carrier is natural starch, which is composed of amylose and amylopectin. Natural starch is starch such as is available as an extract from natural sources, for example, from rice, potatoes, corn, and wheat. Natural starch is a commercially customary product and as such is readily available. As carrier materials it is possible to use one or more of the compounds mentioned above, selected in particular from the group of the alkali metal carbonates, alkali metal sulfates, alkali metal phosphates, zeolites, water-soluble phyllosilicates, alkali metal silicates, polycarboxylates, cellulose ethers, polyacrylate/polymethacrylate, and starch. Particularly suitable mixtures are those of alkali metal carbonates, especially sodium carbonate, alkali metal silicates, especially sodium silicate, alkali metal sulfates, especially sodium sulfate, and zeolites.

Suitable silicones are customary organopolysiloxanes which may contain finely divided silica, which in turn may also have been silanized. Such organopolysiloxanes are described, for example, in the European patent application EP 0496510 A1. Particularly preferred polydiorganosiloxanes and especially polydimethyl siloxanes are those which are known from the prior art. Suitable polydiorganosiloxanes have a virtually linear chain and a degree of oligomerization of from 40 to 1500. Examples of suitable substituents are methyl, ethyl, propyl, isobutyl, tert-butyl, and phenyl. Also suitable are amino-, fatty acid-, alcohol-, polyether-, epoxy-, fluoro-, glycoside- and/or alkyl-modified silicone compounds, which at ambient temperature may be present in either liquid or resin form. Suitability extends to simethicones, which are mixtures of dimethicones having an average chain length of from 200 to 300 dimethylsiloxane units and hydrogenated silicates. As a general rule, the silicones in general and the polydiorganosiloxanes in particular include finely divided silica, which may also have been silanized. Particularly suitable in the context of the present invention are silica-containing dimethylpolysiloxanes. Advantageously, the polydiorganosiloxanes have a Brookfield viscosity at 25° C. (Spindel 1, 10 rpm) in the range from 5000 mPas to 30 000 mPas, in particular from 15 000 to 25 000 mPas. The silicones are used preferably in the form of their aqueous emulsions. In general, the silicone is added with stirring to the initial water charge. If desired, the viscosity of the aqueous silicone emulsions may be increased by adding thickeners, such as are known from the prior art. These thickeners may be organic and/or inorganic in nature; particular preference is given to nonionic cellulose ethers such as methylcellulose, ethylcellulose, and mixed ethers such as methylhydroxyethylcellulose, methylhydroxypropylcellulose, methylhydroxybutylcellulose, and also anionic carboxycellulose types such as sodium carboxymethylcellulose (abbreviation: CMC). Particularly suitable thickeners are mixtures of CMC to nonionic cellulose ethers in a weight ratio of from 80:20 to 40:60, in particular from 75:25 to 60:40. In general, and especially when the thickener mixtures described are added, advisable use concentrations are from about 0.5 to 10%, in particular from 2.0 to 6%, by weight, calculated as thickener mixture and based on aqueous silicone emulsion. The amount of silicones of the type described in the aqueous emulsions is advantageously in the range from 5 to 50% by weight, in particular from 20 to 40% by weight, calculated as silicones and based on aqueous silicone emulsion. In a further advantageous embodiment, the aqueous silicone solutions receive, as a thickener, starch obtainable from natural sources, such as from rice, potatoes, corn, and wheat, for example. The starch is present advantageously in amounts of from 0.1 up to 50% by weight, based on silicone emulsion, and in particular is in a mixture with the above-described thickener mixtures of sodium carboxymethylcellulose and a nonionic cellulose ether in the amounts already specified. To prepare the aqueous silicone emulsions an appropriate procedure is to subject any thickeners present to preswelling in water before adding the silicones. The silicones are appropriately incorporated with the aid of effective stirring and mixing devices.

Fragrances

As perfume oils and/or fragrances it is possible to use certain odorant compounds, examples being the synthetic products of the ester, ether, aldehyde, ketone, alcohol and hydrocarbon type. Odorant compounds of the ester type are, for example, benzyl acetate, phenoxyethyl isobutyrate, p-tert-butylcyclohexyl acetate, linalyl acetate, dimethylbenzylcarbinyl acetate, phenylethyl acetate, linalyl benzoate, benzyl formate, ethyl methylphenylglycinate, allyl cyclohexylpropionate, styrallyl propionate, and benzyl salicylate. The ethers include, for example, benzyl ethyl ether; the aldehydes include, for example, the linear alkanals having 8-18 carbon atoms, citral, citronellal, citronellyloxyacetaldehyde, cyclamen aldehyde, hydroxycitronellal, lilial, and bourgeonal; the ketones include, for example, the ionones, α-isomethylionone and methyl cedryl ketone; the alcohols include anethole, citronellol, eugenol, geraniol, linalool, phenylethyl alcohol and terpineol; and the hydrocarbons include primarily the terpenes such as limonene and pinene. Preference, however, is given to the use of mixtures of different odorants, which together produce an appealing fragrance note. Such perfume oils may also contain natural odorant mixtures, such as are obtainable from plant sources, examples being pine oil, citrus oil, jasmine oil, patchouli oil, rose oil or ylang-ylang oil. Likewise suitable are muscatel, sage oil, camomile oil, clove oil, balm oil, mint oil, cinnamon leaf oil, lime blossom oil, juniperberry oil, vetiver oil, olibanum oil, galbanum oil, and labdanum oil, and also orange blossom oil, neroli oil, orangepeel oil, and sandalwood oil.

The fragrances may be incorporated directly into the compositions of the invention; alternatively, it may be advantageous to apply the fragrances to carriers which intensify the adhesion of the perfume on the laundry and, by means of slower fragrance release, ensure long-lasting fragrance of the textiles. Materials which have become established as such carriers are, for example, cyclodextrins, it being possible in addition for the cyclodextrin-perfume complexes to be further coated with other auxiliaries.

Standardizers

If desired, the final formulations may further comprise inorganic salts as fillers and standardizers, such as sodium sulfate, for example, which is present preferably in amounts of from 0 to 10%, in particular from 1 to 5%, by weight based on the composition.

### EXAMPLES

Surfactant granules were blended with pulverulent formulating components to produce premixes which were compressed to laundry detergent tablets in a tableting press. The pressed compact was formulated so as to give in each case two series of tablets differing in their hardness. The surfactant granules which led to the inventive tablets H1 and H2 and also H3 and H4 contained 5% HME (H1, H2: ring-opening product of 1,2-decene epoxide and an adduct of 2 P0+6 EO with a C_{12/14} coconut fatty alcohol; H3, H4: ring-opening product of 1,2-dodecene epoxide and an adduct of 7 EO with a C_{13/15} oxo alcohol) based on the overall premix, while comparative granules which gave the tablets A1 and A2 on compression contained the corresponding amount of C_{12/}₁₄ coconut fatty alcohol +7 EO (Dehydol® LT 7, Cognis Deutschland GmbH). The inventive tablets F1 to F4, and also C1 and C2, obtained from the mixtures differ only in hardness, not in composition. The com position of the premixes for compression is shown in table 1.

TABLE 1
Composition of the tablets (amount in % by weight):

| Composition | H1, H2 | H3, H4 | A1, A2 |
|---|---|---|---|
| Dodecylbenzenesulfonate, | 4.0 | 7.0 | 4.0 |
| sodium salt | | | |
| Lauryl sulfate, sodium salt | 4.0 | 4.0 | 4.0 |
| Hydroxy mixed ether | 5.0 | 5.0 | — |
| Coconut fatty acid methyl | 3.0 | — | 8.0 |
| ester + 3.6EO | | | |
| Palm kernel fatty acid, | 2.0 | 2.0 | 2.0 |
| sodium salt | | | |
| Polycarboxylate | 5.0 | 5.0 | 5.0 |
| Sodium carbonate | 10.0 | 10.0 | 10.0 |
| Zeolite A | 25.0 | 25.0 | 25.0 |
| Sodium silicate | 4.0 | 4.0 | 4.0 |
| Silicone defoamer (10% | 5.0 | 5.0 | 5.0 |
| active substance) | | | |
| Sodium percarbonate | 14.0 | 14.0 | 14.0 |
| TAED | 3.0 | 3.0 | 3.0 |
| Microcrystalline cellulose | 7.0 | 7.0 | 7.0 |

| | |
|---|---|
| Sodium sulfate | ad 100 |

Performance testing. The hardness of the tablet was determined as the fracture hardness. A measurement is made of the force which acts on the side faces of the tablet and which the tablet withstands. In order to assess the dissolution characteristics the tablets were placed on a wire frame which was put in water (0° d [German hardness], 25° C.). The tablets were completely surrounded by water. A measurement was made of the disintegration time from immersion until complete dissolution. The results are compiled in table 2.

TABLE 2
Fracture hardness and disintegration rate

| | F1 | F3 | C1 | F2 | F4 | C2 |
|---|---|---|---|---|---|---|
| Fracture hardness [N] | 43 | 40 | 46 | 57 | 61 | 55 |
| Disintegration | 20 | 10 | 80 | 45 | 15 | >200 |
| rate [s] | | | | | | |

1. Laundry detergent and cleaning product tablets comprising compacted particulate precursors, comprising surfactants, builders, and, where appropriate, further laundry detergent and cleaning product ingredients, characterized in that they comprise surfactants from the group of the hydroxy mixed ethers.

2. Laundry detergent and cleaning product tablets of claim 1, characterized in that they comprise hydroxy mixed ethers of the formula (I) 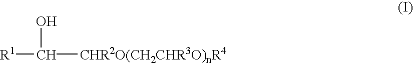
in which R¹ is a linear or branched alkyl radical having from 2 to 8 carbon atoms, R² is hydrogen or a linear or branched alkyl radical having from 2 to 18 carbon atoms, R³ is hydrogen or methyl, R⁴ is a linear or branched alkyl and/or alkenyl radical having from 6 to 22 carbon atoms, and n stands for numbers from 1 to 50, with the proviso that the sum of the carbon atoms in the radicals R¹ and R² is at least 4.

3. Laundry detergent and cleaning product tablets of claims 1 and/or 2, characterized in that they comprise hydroxy mixed ethers of the formula (I) in which R² is hydrogen.

4. Laundry detergent and cleaning product tablets of at least one of claims 1 to 3, characterized in that, based on the tablet weight, they contain from 0.1 to 20% by weight of hydroxy mixed ethers.

5. Laundry detergent and cleaning product tablets of at least one of claims 1 to 4, characterized in that they comprise further anionic, nonionic, cationic and/or zwitterionic surfactants.

6. Laundry detergent and cleaning product tablets of at least one of claims 1 to 5, characterized in that they further comprise builders and/or disintegrants.

7. Laundry detergent and cleaning product tablets of at least one of claims 1 to 5, characterized in that they are obtained by compressing a particulate precursor comprising at least one kind of surfactant granules and at least one subsequently admixed pulverulent component.

8. Laundry detergent and cleaning product tablets of claim 7, characterized in that the premix for compression has a bulk density of at least 500 g/l.

9. Laundry detergent and cleaning product tablets of at least one of claims 7 and/or 8, characterized in that the (or one of the) subsequently admixed pulverulent components is a zeolite of the faujasite type having particle sizes of less than 100 μm.

10. Laundry detergent and cleaning product tablets of at least one of claims 1 to 9, characterized in that they further comprise one or more substances from the group consisting of builders, bleaches, bleach activators, enzymes, pH modifiers, fragrances, perfume carriers, fluorescents, dyes, foam inhibitors, silicone oils, antiredeposition agents, optical brighteners, graying inhibitors, color transfer inhibitors, and corrosion inhibitors.
